(19) United States
(12) Patent Application Publication
(10) Pub. No.: US 2011/0265296 A1
(43) Pub. Date: Nov. 3, 2011

(54) Recessed Attachment Point

(76) Inventor: Rohan Perkins, Kurrajong (AU)

(21) Appl. No.: 12/990,233

(22) PCT Filed: Apr. 29, 2009
(86) PCT No.: PCT/AU2009/000534

§ 371 Date: Jan. 21, 2011

(30) Foreign Application Priority Data
Apr. 29, 2008 (AU) 2008902114

(51) Int. Cl. B60P 7/00

(52) U.S. Cl. 24/595.1

(57) ABSTRACT

A recessed attachment point is mountable in a surface for attaching tie downs, life lines, etc. to the surface. The attachment point comprises a housing including a mounting plate having a central opening and a well extending from the central opening. An attachment member is slidingly connected to the housing such that it slides between a first (retracted) position in which an open end of the attachment member is retracted into the well and a second (extended) position in which the open end of the attachment member at least partially extends out of the well and through the opening in the mounting plate.

### INTRODUCTION

The present invention relates to surface mounted attachment points and in particular provides an attachment point retractable into a recess.

### BACKGROUND

The simplest available surface mounted attachment points include for example saddles and eyes which are fixed to project from a surface to which they are attached and therefore represent a potential hazard which can be kicked or which can snag clothing or lines (i.e. ropes on a boat) etc.

Other attachment points are hinged to fold into a recess but these are often more complicated to manufacture and can have reduced strength if force is applied in certain directions.

### SUMMARY

The present invention provides a recessed attachment point, mountable in a surface and comprising a housing including a mounting plate having a central opening and a well extending from the central opening, and an attachment member slidingly connected to the housing and slidable between a first position in which an open end of the attachment member is retracted into the well and a second position in which the open end of the attachment member at least partially extends out of the well and through the opening in the mounting plate.

The attachment member may be biased into the retracted position by a spring or other suitable biasing means, however if the surface in which the recessed attachment point is mounted in horizontal retraction may be achieved by gravity.

For simplicity of manufacture, the well may be cylindrical, however, other shapes may be employed including rectangular and cross shapes (i.e. two intersecting rectangles) as well as shapes where the x-section varies through the length of the well (in the sliding direction of the attachment member).

In one such embodiment the x-section of the well is rectangular at the bottom of the well but is flared at the top (outwardly along the long axis of the rectangle) to provide access to grip the attachment member.

For watertight applications the well may be formed without openings and its connection to the mounting plate is sealed such that by sealing around the recessed attachment point where it is fitted to the surface, a watertight arrangement is provided. Alternatively a watertight cap may be located behind the recessed attachment point and sealed to a back of the surface to which the recessed attachment point is mounted. A drainage port may be provided in the housing (in the case of a sealed housing) or the cup to which a drain hose may be connected to carry away water which may accumulate in either.

### BRIEF DESCRIPTION OF THE DRAWINGS

Embodiments of a recessed attachment point will now be described in detail with reference to the accompanying drawings in which:

FIG. 1 shows a perspective view of a recessed attachment point mounted in a surface;

FIG. 2 is a plan view of the recessed attachment point of FIG. 1, shown in isolation;

FIG. 3 is a sectional front view through A-A′ in FIG. 2 with an attachment member of the recessed attachment point in the retracted position;

FIG. 4 is a sectional front view through A-A′ in FIG. 2 with an attachment member of the recessed attachment point in the extended position;

FIG. 5 is a sectional front view of an alternative design of recessed attachment point similar to that shown in FIGS. 1-4 but contained in a sealed housing;

FIG. 6 is a sectional front view of a further alternative design of recessed attachment point similar to that shown in FIGS. 1-4, shown mounted to a surface and including an additional rear cover to provide waterproofing;

FIG. 7 is a plan view of a recessed attachment point similar to that of FIGS. 1-4, but with a non-cylindrical well, the attachment point being shown in isolation;

FIG. 8 is a sectional front view through B-B′ in FIG. 7 with an attachment member of the recessed attachment point in the retracted position;

FIG. 9 is a sectional front view through C-C′ in FIG. 7 with the attachment member of the recessed attachment point in the retracted position; and

FIG. 10 is a sectional front view of an alternative design of recessed attachment point similar to that shown in FIGS. 1-4 but having an eye bolt with a circular eye.

### DETAILED DESCRIPTION OF EMBODIMENTS OF A RECESSED ATTACHMENT POINT

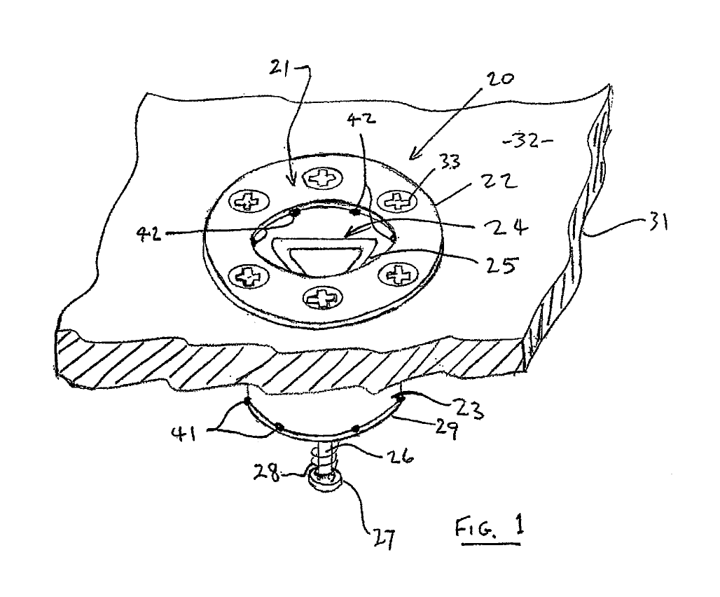

Referring to FIG. 1 a recessed attachment point 20 is shown in perspective view mounted in a surface 32 of sheet material 31 by fasteners 33 which may be screws engaged in the sheet material or a backing piece (not shown) or may be bolts and nuts (such as shown in shown in FIG. 6). The fasteners 33 are fitted through countersunk holes 43 in a deck plate 22 of the recessed attachment point, such that the deck plate may be pulled into close engagement with the surface 32 and if necessary sealed thereto with a gasket, or a flowable, settable sealing material such as a silicon rubber (not shown). The deck plate 22 forms the mounting part of a body 21, and includes a central opening 45 adjacent to which a tubular wall 23 is attached to the back surface of the deck plate 22, by internal spot welds 42 and/or external spot welds 48, to form a well 46 extending through an opening in the surface 32. The bottom of the well 46 is closed by a base plate 29 connected to the rear periphery of the wall 23 by internal spot welds 47 and/or external spot welds 41.

The base plate 29 has a central hole 44 through which an attachment member 24 is mounted with a clearance fit. The attachment member comprises a shaft 26 which passes through the hole 44 and is slidable therein, a retention piece 27 sized larger than the hole 44 to retain the attachment member from being removed from the hole 44 and an eye portion 25 to which a strap, lashing, clip or other attachment device may be removably connected. A spring 28 or other biasing means is provided between the retention piece 27 and the base plate 29 to bias the attachment member towards a position in which the eye 25 is substantially or completely retained within the well 26.

The retention piece 27 is shown in FIGS. 2 & 3 as an annular plate passing over the end of the shaft 26 and spot welded 49 into place. Alternatively the retention piece can be a nut or other threaded member screwed onto a threaded end of the shaft 26.

In use the eye of the attachment member is pulled out of the well, compressing the spring 28 until the retention piece 27 fully compresses the spring 28. In an alternative arrangement, the retention piece may be designed to encompass the spring such that the retention piece 27 hits the base plate 29 before the spring is fully compressed to protect the spring from undue stress. A strap, lashing, clip or other attachment device is then connected to the eye to fasten an item to the surface 32. In this case the eye 25 of the attachment member 24 is triangular, however other shapes such as circular or rectangular eyes can also be provided as will be seen below.

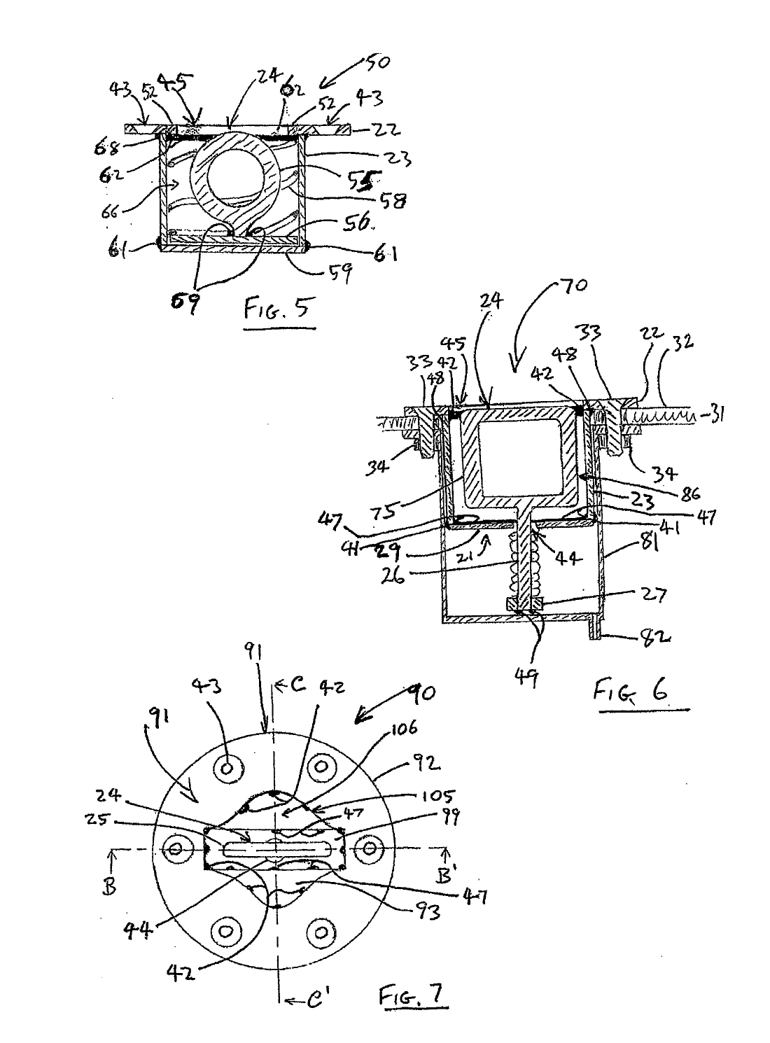

Referring to FIG. 5 an alternative embodiment of a recessed attachment point 50 is illustrated in sectional view. In this embodiment the body 51, is formed by the deck plate 22, the tubular wall 23 and a base plate 59 which has no opening. The tubular wall is connected to the deck plate 22 by internal welds 62 and/or external welds 68 at least one of which is a seam weld to form a sealed connection. The tubular wall is also connected to the base plate 29 by internal welds (not shown for clarity) and/or external welds 61 at least one of which is a seam weld to form a sealed connection.

By sealing the deck plate 22 to the surface in which it is mounted this embodiment allows a sealed installation for use in exposed locations such as the open deck of a yacht.

Because the base plate 59 has no opening, the retention plate 57 is located inside the well 66 with a relatively close tolerance fit and is retained within the well 66 by an overhang 52 of the deck plate 22 extending inwardly over the edge of the tubular wall 23. The attachment eye 55 is welded directly to the retention plate 57 by welds 69 and the eye is biased into the well by a spring 58 acting between the underside of the overhang 52 and the retention plate 57.

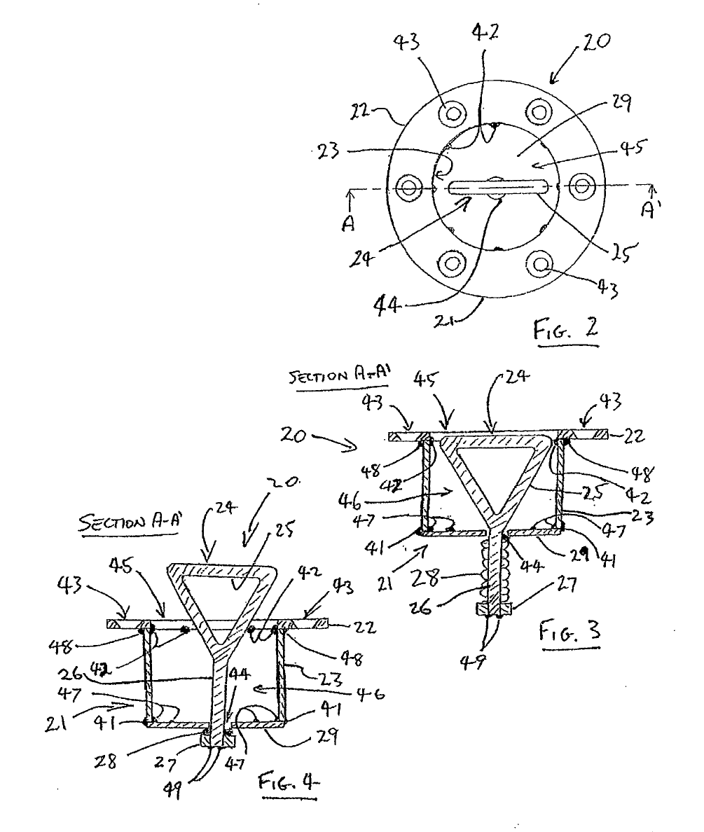

FIG. 6 shows another embodiment that is suitable for use in exposed locations. The recessed attachment point 70 illustrated in sectional view in FIG. 6 is shown mounted to a surface 32 by bolts 33 and nuts 34. This embodiment is essentially identical to that of FIGS. 1-4 except that the attachment eye 75 is square shaped instead of triangular. The other difference in this embodiment is that a waterproofing cup 81 is mounted behind the body 21 of the recessed attachment point, with the same bolts 33 and nuts 34 that attach the deck plate 22 to the front surface 32. With suitable sealant between the cup 81 and the sheet material 31 water cannot penetrate to the inside of the sheet material even though there is a hole in the base plate 29 and possibly an imperfect join between the body components 22, 23, 29 forming the well 86. Alternatively the cup may itself be resilient and capable of sealing engagement in which case a plate may be required over the mounting flange 83 of the cup 81. The cup may optionally be provided with a drain port 82 for connection of a drain hose to carry away any liquid that might otherwise accumulate in the cup.

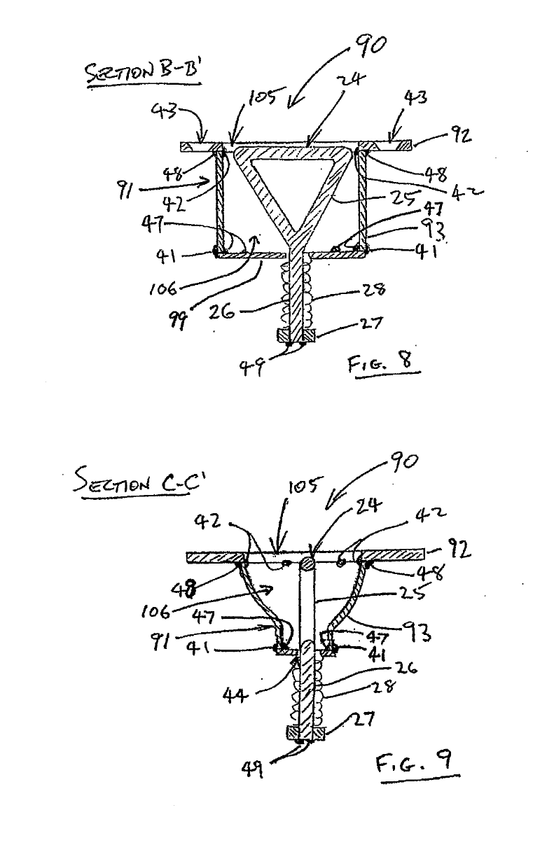

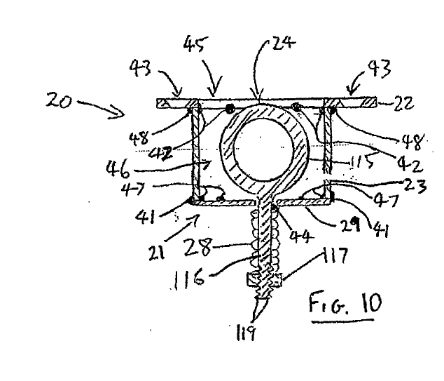

The recessed attachment point 90 shown in FIGS. 7, 8 & 9 is again similar to that of FIGS. 1-4 except that the shape of the well 106 is not cylindrical as it is in the earlier embodiments. In this case the well is rectangular in cross section at the base and flared in the centre at the deck plate to allow easy finger access to the attachment member 24. To achieve this, the deck plate 92 has an opening 105 which is elongate, with squared off ends on its two short sides with the long sides are flared outwardly in their centres.

The wall 93 of the well 106 has a complex shape, with a rectangular cross section where it joins the rectangular base plate 99 and a cross section where it joins the deck plate 92, which is complementary with the shape of the opening 105.

In FIG. 10 a further variation of the recessed attachment point of FIGS. 1-4 is illustrated. In this variation the attachment member 24 is an eye bolt having a round eye 115 and a shaft 116 threaded 119 at one end and retained in the hole 44 by one or more nuts 117. The nut or nuts 117 may be a nyloc™ style self locking nut or alternatively a pair of conventional nuts can be locked together. A single nut might also be glued or spot welded to prevent unscrewing.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A recessed attachment point, mountable in a surface and comprising a housing including a mounting plate having a central opening and a well extending from the central opening, and an attachment member slidingly connected to the housing and slidable between a first position in which an open end of the attachment member is retracted into the well and a second position in which the open end of the attachment member at least partially extends out of the well and through the opening in the mounting plate, the attachment member comprising a slide, slidingly connected to the housing and the open end connected to the slide, the open end comprising an eye.

2. The attachment point of claim 1 wherein the attachment member is biased into the first, retracted position by a biasing means.

3. The attachment point of claim 2 wherein the biasing means is gravity.

4. The attachment point of claim 2 wherein the biasing means is a spring.

5. The attachment point of claim 1 wherein the well is cylindrical in shape.

6. The attachment point of claim 1 wherein the well is rectangular in cross section.

7. The attachment point of claim 1 wherein the well is cross shaped (that is, two intersecting rectangles) in cross section.

8. The attachment point as claimed in claim 1 wherein the well has a cross section shape which varies through a length of the well in the sliding direction of the attachment member.

9. The attachment point as claimed in claim 1 wherein the x-section of the well is rectangular at a bottom of the well and flared at a top end adjacent the mounting plate to provide access to grip the attachment member.

10. The attachment point as claimed in claim 1 wherein the well is formed without openings and its connection to the mounting plate is sealed such that by sealing around the recessed attachment point where it is fitted to the surface, a watertight arrangement is provided.

11. The attachment point of claim 10 wherein in the housing is provided with a drainage port to which a drain hose is connected to carry away water which may accumulate in the housing.

12. The attachment point as claimed in claim 1 wherein a watertight cap is located behind the recessed attachment point and sealed to a back of the surface to which the recessed attachment point is mounted.

13. The attachment point of claim 12 wherein the cup is provided with a drainage port to which a drain hose is connected to carry away water which may accumulate in the cup.

14. The attachment point of claim 1 wherein the slide comprises a shaft passing through an opening in a base plate of the well.

15. The attachment point of claim 1 wherein the slide comprises a retention plate retained in the well by an opening in a deck plate having edges overhanging the well.
